(19) United States
(12) Patent Application Publication
(10) Pub. No.: US 2015/0199735 A1
(43) Pub. Date: Jul. 16, 2015

(54) PRICING DATA ACCORDING TO QUALITATIVE IMPROVEMENT IN A QUERY RESULT SET

(71) Applicant: International Business Machines Corporation, Armonk, NY (US)

(72) Inventors: TAMER E. ABUELSAAD, Somers, NY (US); Gregory J. Boss, Saginaw, MI (US); John M. Ganci, JR., Cary, NC (US); Craig M. Trim, Sylmar, CA (US)

(73) Assignee: International Business Machines Corporation, Armonk, NY (US)

(21) Appl. No.: 14/153,415

(22) Filed: Jan. 13, 2014

(51) Int. Cl. G06Q 30/02

(52) U.S. Cl. CPC G06Q 30/0283

(57) ABSTRACT

A set of data cubes is identified for a query. A first subset of qualified data cubes is selected from the set. A first subset of needed cubes from the first subset is usable to form an unimproved result set for a first price, achieving a first value of a qualitative aspect. A second subset of participating data cubes is selected from the first subset. A second value of the qualitative aspect of a result set of the query is computed. A portion of the second value of the qualitative aspect forms a degree of qualitative contribution of a participating data cube for price-adjusting the participating data cube. A total price of using the second subset for the query is computed including the improvement-based adjusted price. The second subset, result set, second value, and total price are comparatively presented with the first price and the first value.

### TECHNICAL FIELD

The present invention relates generally to a method, system, and computer program product for selling quanta of data. More particularly, the present invention relates to a method, system, and computer program product for pricing data according to qualitative improvement in a query result set.

### BACKGROUND

A data store is a repository of data. Generally, the data in a data store does not have to conform to any particular form or structure. Typically, data sourced from several different sources of different types is stored in a data store, and the different sources provide their data in varying formats, organized in different ways, and often in unstructured form. Several methods for querying data from one or more data stores are presently in use.

### SUMMARY

An embodiment includes a method for pricing data according to a qualitative improvement of a result from using the data. The embodiment identifies a set of data cubes according to a set of cube selection parameters, wherein a data cube in the set of data cubes comprises a quantum of data configured for trading in exchange for a payment, the set of data cubes being usable for answering a query. The embodiment selects a first subset of qualified data cubes from the set of data cubes, wherein a first subset of needed data cubes from the first subset of data cubes is usable to execute the query and form an unimproved result set for a first price, the unimproved result set achieving a first value of a qualitative aspect. The embodiment selects a second subset of participating data cubes from the first subset of qualified data cubes. The embodiment computes, using a processor and a memory, a second value of the qualitative aspect of a result set of the query, wherein at least a portion of the second value of the qualitative aspect is contributed by a participating data cube from the second subset, the portion forming a degree of qualitative contribution of the participating data cube, wherein the second value of the qualitative aspect of the result set exceeds the first value of the qualitative aspect of the unimproved result set. The embodiment adjusts a price of the participating data cube according to the degree of qualitative contribution of the participating data cube, forming an improvement-based adjusted price. The embodiment computes a total price of using the second subset of participating data cubes for the query, the computing including the improvement-based adjusted price. The embodiment comparatively presents the second subset of participating data cubes, the result set, the second value of the qualitative aspect, and the total price of using the second subset of participating data cubes for the query, in comparison with the first price and the first value of the qualitative aspect.

Another embodiment includes a computer program product for pricing data according to a qualitative improvement of a result from using the data. The embodiment further includes one or more computer-readable tangible storage devices. The embodiment further includes program instructions, stored on at least one of the one or more storage devices, to identify a set of data cubes according to a set of cube selection parameters, wherein a data cube in the set of data cubes comprises a quantum of data configured for trading in exchange for a payment, the set of data cubes being usable for answering a query. The embodiment further includes program instructions, stored on at least one of the one or more storage devices, to select a first subset of qualified data cubes from the set of data cubes, wherein a first subset of needed data cubes from the first subset of data cubes is usable to execute the query and form an unimproved result set for a first price, the unimproved result set achieving a first value of a qualitative aspect. The embodiment further includes program instructions, stored on at least one of the one or more storage devices, to select a second subset of participating data cubes from the first subset of qualified data cubes. The embodiment further includes program instructions, stored on at least one of the one or more storage devices, to compute a second value of the qualitative aspect of a result set of the query, wherein at least a portion of the second value of the qualitative aspect is contributed by a participating data cube from the second subset, the portion forming a degree of qualitative contribution of the participating data cube, wherein the second value of the qualitative aspect of the result set exceeds the first value of the qualitative aspect of the unimproved result set. The embodiment further includes program instructions, stored on at least one of the one or more storage devices, to adjust a price of the participating data cube according to the degree of qualitative contribution of the participating data cube, forming an improvement-based adjusted price. The embodiment further includes program instructions, stored on at least one of the one or more storage devices, to compute a total price of using the second subset of participating data cubes for the query, the computing including the improvement-based adjusted price. The embodiment further includes program instructions, stored on at least one of the one or more storage devices, to comparatively present the second subset of participating data cubes, the result set, the second value of the qualitative aspect, and the total price of using the second subset of participating data cubes for the query, in comparison with the first price and the first value of the qualitative aspect.

Another embodiment includes a computer system for pricing data according to a qualitative improvement of a result from using the data. The embodiment further includes one or more processors, one or more computer-readable memories and one or more computer-readable tangible storage devices. The embodiment further includes program instructions, stored on at least one of the one or more storage devices for execution by at least one of the one or more processors via at least one of the one or more memories, to identify a set of data cubes according to a set of cube selection parameters, wherein a data cube in the set of data cubes comprises a quantum of data configured for trading in exchange for a payment, the set of data cubes being usable for answering a query. The embodiment further includes program instructions, stored on at least one of the one or more storage devices for execution by at least one of the one or more processors via at least one of the one or more memories, to select a first subset of qualified data cubes from the set of data cubes, wherein a first subset of needed data cubes from the first subset of data cubes is usable to execute the query and form an unimproved result set for a first price, the unimproved result set achieving a first value of a qualitative aspect. The embodiment further includes program instructions, stored on at least one of the one or more storage devices for execution by at least one of the one or more processors via at least one of the one or more memories, to select a second subset of participating data cubes from the first subset of qualified data cubes. The embodiment further includes program instructions, stored on at least one of the one or more storage devices for execution by at least one of the one or more processors via at least one of the one or more memories, to compute a second value of the qualitative aspect of a result set of the query, wherein at least a portion of the second value of the qualitative aspect is contributed by a participating data cube from the second subset, the portion forming a degree of qualitative contribution of the participating data cube, wherein the second value of the qualitative aspect of the result set exceeds the first value of the qualitative aspect of the unimproved result set. The embodiment further includes program instructions, stored on at least one of the one or more storage devices for execution by at least one of the one or more processors via at least one of the one or more memories, to adjust a price of the participating data cube according to the degree of qualitative contribution of the participating data cube, forming an improvement-based adjusted price. The embodiment further includes program instructions, stored on at least one of the one or more storage devices for execution by at least one of the one or more processors via at least one of the one or more memories, to compute a total price of using the second subset of participating data cubes for the query, the computing including the improvement-based adjusted price. The embodiment further includes program instructions, stored on at least one of the one or more storage devices for execution by at least one of the one or more processors via at least one of the one or more memories, to comparatively present the second subset of participating data cubes, the result set, the value of the qualitative aspect, and the total price of using the second subset of participating data cubes for the query, in comparison with the first price and the first value of the qualitative aspect.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an application for pricing data according to qualitative improvement in a query result set in accordance with an illustrative embodiment;

FIG. 4 depicts an example set of sellers' features on an example user interface in accordance with an illustrative embodiment;

FIG. 5 depicts an example set of users' features on an example user interface in accordance with an illustrative embodiment; and

FIG. 6 depicts a flowchart of an example process for pricing data according to qualitative improvement in a query result set in accordance with an illustrative embodiment.

### DETAILED DESCRIPTION

A data cube is a quantum of data that can be sold, purchased, borrowed, installed, loaded, or otherwise used in a computation. Much like an application store contains applications, a data store according to the illustrative embodiments contains numerous data cubes.

In a manner similar to obtaining an application from an application store for use on a device, the illustrative embodiments contemplate that a user can obtain, in exchange for a payment, one or more data cubes to use in the user's query. For example, a user can use a shopping cart application to select data cubes from a data store. The user can then buy, borrow, lease, loan, download, install, or otherwise trade, for use in exchange for a payment, the selected data cubes in the manner of an embodiment.

For example, in one embodiment, the user constructs a query and uses the data cubes to answer the query. In another embodiment, the user is a system or an application, which consumes the data cubes to answer a query or for other suitable purpose. While some embodiments are described with respect to a user and a query, the illustrative embodiments are usable by any type of user, system, or application, for any type of use, and such usage is contemplated within the scope of the illustrative embodiments.

Computing resources, such as processor time, memory, and storage space, are often billed according to their use. An amount of billing for a computing resource is usually proportional to an amount of time and the size of the resource used by a user.

The illustrative embodiments recognize that presently data is not sold or traded as data cubes, but in conjunction with some application or environment. For example, map data is sold as a bundle with a navigation application, financial data is sold in conjunction with a financial analysis application, as so on. The illustrative embodiments recognize that selling or trading data by bundling with an application restricts the utility of the data as well as the market for the data. For example, a user who wants to use certain map data must also buy or subscribe to a specific application to use the data.

The illustrative embodiments recognize that data is artificially tied to applications. The illustrative embodiments recognize that much of the data is, or can be, a generalized commodity, which can be traded independently from any trade involving applications or other similar bundling restrictions.

The illustrative embodiments recognize that making data available for use, such as in a query, has value. The illustrative embodiments further recognize that unlike the billing for computing resources, the amount of data used and the period of the usage are not adequate indicators of the value of the data. Consequently, the illustrative embodiments recognize that the pricing of data cubes has to be use-related, such that the price a user pays for a data cube, or a part thereof, is related to the utility of that data cube, or a part thereof, in the user's query. Even when generic data is available for purchase today, the pricing of that data is static, regardless of the utility of the data to different users. Furthermore, where generic data can be purchased, a user has to pay first to purchase the data, in order to be able to determine the data's utility.

The illustrative embodiments used to describe the invention generally address and solve the above-described problems and other problems related to trading in data. The illustrative embodiments provide a method, system, and computer program product for pricing data according to qualitative improvement in a query result set.

An embodiment allows a data source (seller) to define how they want to control the use of the data cube they contribute to a data store. The embodiment further allows the seller to define certain pricing parameters to use when the data cube is selected for participating in a query.

An embodiment receives a query from a user, application, or system (buyer). The embodiment identifies a set of data cubes to answer the query. For example, in one embodiment, the user selects the set of cubes in a shopping cart application. In another embodiment, the set is specified as a default set in a user profile, and is to be used for user's queries. Another embodiment, selects the set of cubes according to user's instructions or selection criteria.

The embodiment eliminates, removes, or otherwise disqualifies zero or more data cubes from the set based on any pricing or use restrictions prescribed by the seller. For example, a seller of a healthcare-related data cube may not wish for the cube to participate in a query where it becomes possible to identify an individual patient. Thus, even though a healthcare-related query can use the data cube, the data cube may be disqualified if the nature of the query or combining the data cube with another data cube in the query can lead to an individual's identification.

As another example, only a portion of a particular data cube may be suitable for participating in a query but the seller of the data cube may prohibit partial use of the data cube. These examples of data cube disqualification are not intended to be limiting on the illustrative embodiments. Specific circumstances can give rise to any number of reasons for disqualification of a data cube, and the same are contemplated within the scope of the illustrative embodiments.

Furthermore, some data cubes may be eliminated from the identified set of data cubes due to a restriction that the buyer places upon the data cube selection. For example, a user can specify that no data cube whose pricing exceeds a certain amount be used in executing the query. Accordingly, even if a data cube is not disqualified due to a seller-imposed restriction, the pricing of the data cube might eliminate the cube from consideration in the query. Again, many other buyer-imposed conditions can limit or expand the set of data cubes that participate in a query, and the same are contemplated within the scope of the illustrative embodiments.

An embodiment further computes or estimates a result set that can be expected by executing the query on the remaining subset of data cubes. One embodiment considers additional data cubes not in the remaining subset but in the set, not in the set, or a combination thereof, to determine whether the qualitative aspects of the result set can be improved by using such additional cubes. The embodiment offers to the user various options for improving a quality of the result set by using these other data cubes.

A qualitative aspect (aspect, quality aspect) of a result set is an indicator of a quality of the result set. The quality of a given result set is a factor of one or more qualitative aspects. For example, a confidence rating of the result set is one example qualitative aspect of the result set. In some cases, the higher the confidence rating of the result set, the higher is the quality of the result set. In some other cases, however, the lower the quality of the result set, the higher is the quality of the result set. Which size of the result set indicates what amount or degree of quality is dependent upon the objective of the query and is specifiable by a user.

As another example, a size of the result set is one example qualitative aspect of the result set. In some cases, the larger the result set, the higher is the quality of the result set. In some other cases, however, the smaller the result set, the higher is the quality of the result set. Which size of the result set indicates what amount or degree of quality is dependent upon the objective of the query and is specifiable by a user.

As another example, an age of the records in the result set is another example qualitative aspect of the result set. In some cases, the older the result set, the higher is the quality of the result set. In some other cases, however, the newer the result set, the higher is the quality of the result set. Which age-range of the result set indicates what quality is dependent upon the objective of the query and is specifiable by a user.

These example qualitative aspects of a result set are described only for the clarity of the operation of an embodiment and are not intended to be limiting on the illustrative embodiments. Many other qualitative aspects are similarly usable with an embodiment and the same are contemplated within the scope of the illustrative embodiments. For example, a proportion of verifiable versus unverifiable data in the result set, a proportion of higher provenance data versus lower provenance data in the result set, a number of columns or dimensions in the result set records, an indication associated with a result set record indicating use by others in similar queries, a value contribution of a record in the result set, a net advantage in a price of including a record versus a saving achieved by the inclusion, and a rarity of a record in the result set, are some more examples of qualitative aspects of a result set. Furthermore, any reference herein to a higher value or a lower value of an artifact, such as of a qualitative aspect, is established either by comparing two or more values of similar artifacts, or by comparing a value of an artifact to a threshold value, or a combination thereof.

Thus, the embodiment allows the user to preview a potential improvement, such as a larger than a threshold improvement in the confidence qualitative aspect or another qualitative aspect of the result set, when additional cubes are included to participate in the query. Such a preview enables the user to revise their conditions, modify the query, or perhaps decide to pay a different price to have the additional data cube included.

Furthermore, an embodiment determines a level of contribution made by a data cube to a result set. The embodiment determines how much contribution a particular data cube makes to a qualitative aspect of the result set of the query. For example, given one query from one user, an example data cube may improve the confidence aspect of a result set by thirty percent. However, given another query from another user, the same example data cube may only improve the confidence aspect of the result set by three percent.

The embodiment recognizes that the same data cube has different value to different users given the different change in a qualitative aspect of a result set obtained using the data cube. The embodiment then ascertains a pricing for the data cube according to how contributory the data cube is to a qualitative aspect of the result set, while complying with any conditions that are imposed on the usage or pricing of the data cube. For example, where a data cube increases a qualitative aspect of a result set by a certain amount, the cube is priced proportionally higher, as compared to where the same data cube affects another result set by less than that amount.

Thus, one embodiment allows a user/buyer to specify and select the data cubes to use in a query. Another embodiment allows a user to preview some other options that the user may not have considered due to some seller-imposed or user-imposed limitation.

Another embodiment allows a user to specify a threshold. When an unconsidered data cube improves the result set by more than the threshold, the embodiment automatically adjusts a condition to allow the data cube to participate in the query, e.g., by increasing a user-specified price threshold to include and pay for the additional data cube.

The illustrative embodiments are described with respect to, certain data formats, structures, rules, conditions, restrictions, qualitative aspects, contributions, levels, data processing systems, environments, components, and applications only as examples. Any specific manifestations of such artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

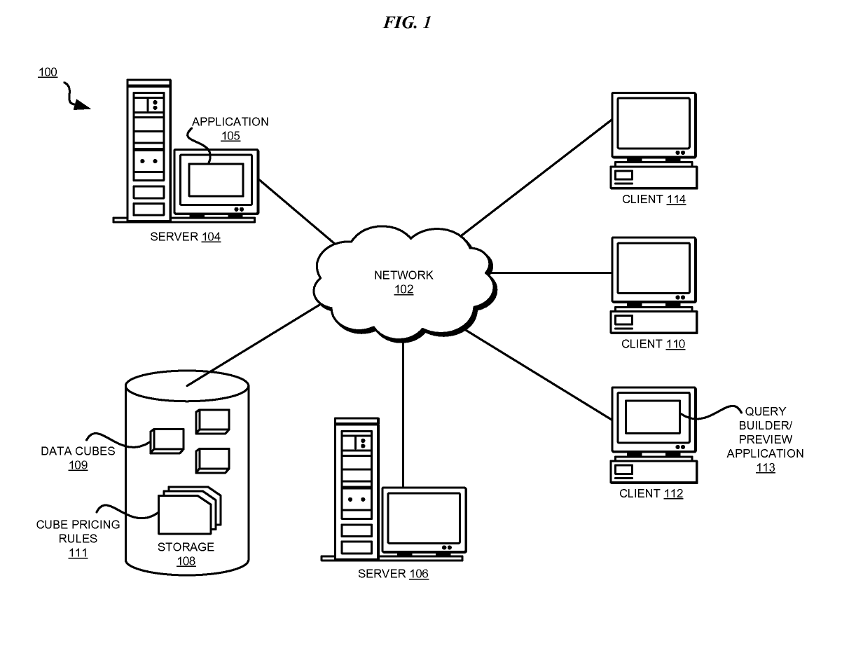

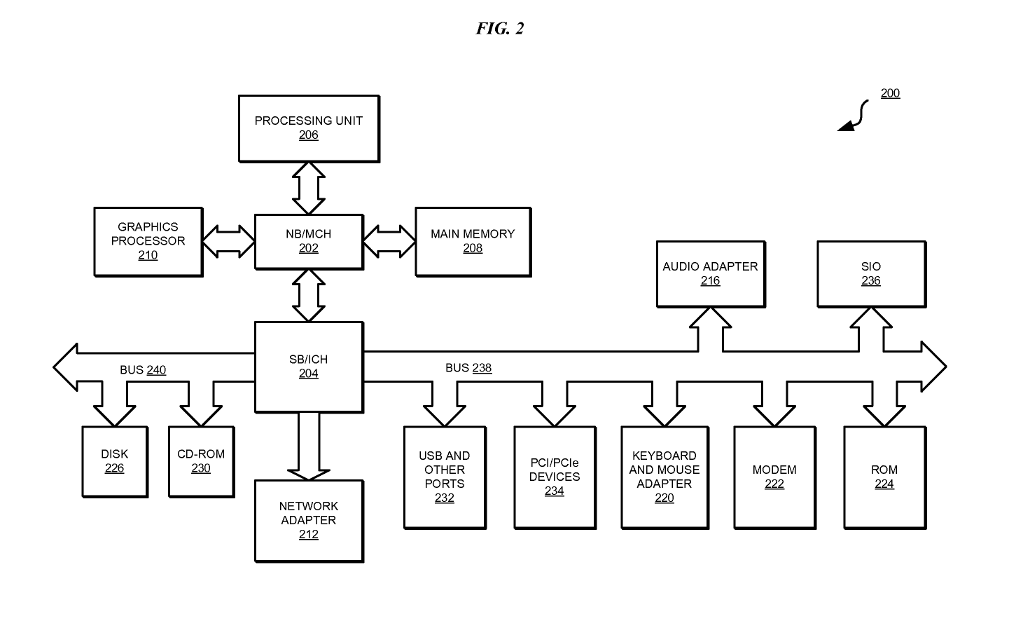

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that are useable in an embodiment. Application 105 in server 104 implements an embodiment described herein. Data cubes 109 are cubes located in a data store, such as a data store using storage 108. Cube pricing rules 111 include one or more pricing rules for a data cube in data cubes 109. Query builder application 113 in client 112 is an example application using which a user or buyer can submit a query to application 105. Application 113 can be implemented in any suitable manner, for example, at a server data processing system, a client data processing system, a server and a client data processing systems, in the data store, or using a browser within the scope of the illustrative embodiments. Furthermore, the query building activity using application 113 can be an indirect activity, such as, instead of expressly specifying the query, by identifying an application that will consume the data cubes, for example, in an implicit query. Using application 113, a user can also preview qualitative aspects of an expected result set to change the composition of the set of cubes that are used to answer the query. Application 105 selects a set of data cubed from data cubes 109, and prices the cubes that participate in the query according to a pricing rule in pricing rules 111.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 and query builder and preview application 113 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

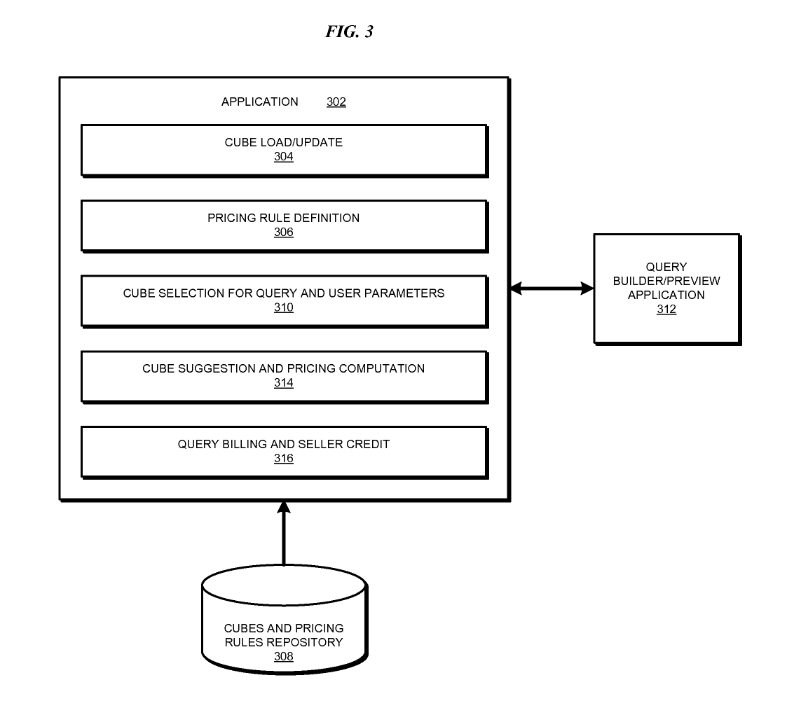

With reference to FIG. 3, this figure depicts a block diagram of an application for pricing data according to qualitative improvement in a query result set in accordance with an illustrative embodiment. Application 302 is an example of application 105 in FIG. 1. The configuration of application 302 depicted in FIG. 3 is only an example to describe the various functions of application 302. From this disclosure, those of ordinary skill in the art will be able to implement similar, additional, or different functions in other configurations as well, and the same are contemplated within the scope of the illustrative embodiments.

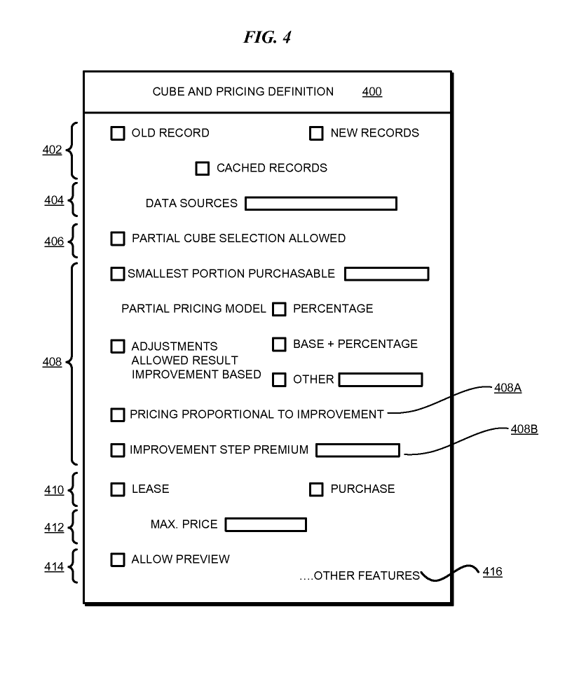

Component 304 allows a seller to load a data cube into a data store, update an existing cube in the data store, or both. Component 306 allows the seller to define one or more pricing rules for a data cube that the seller loads or updates. As an example, in one embodiment, component 306 presents an interface described with respect to FIG. 4 to enable the pricing rule configuration for a data cube. The data cube from component 304, and the one or more pricing rules associated with the data cube are stored in repository 308.

Component 310 interacts with application 312 to receive a query. Application 312 is an example of query builder and preview application 113 in FIG. 1. Component 310 selects a set of cubes from repository 308. Each cube in the selected set of cubes is selected by the user, such as by expressly selecting the cubes from repository 308, specifying one or more cube selection criterion, configuring conditions for cube selection in a user profile, or a combination thereof.

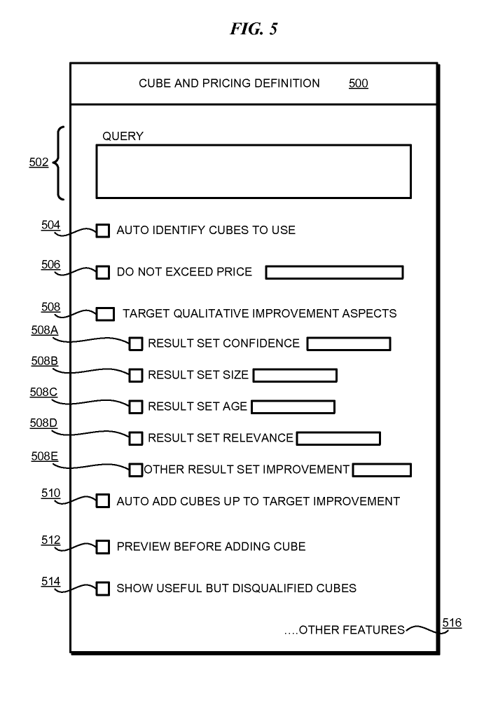

Component 310 further receives a set of user-specified parameters. For example, the user-specified parameters control how the cubes are selected for executing the query, what pricing restrictions are observed in the selection, and several other aspects of building and executing the query to yield a result set. As an example, in one embodiment, component 310 presents an interface described with respect to FIG. 5 to enable the user to input the query and user-specified parameters.

Component 314 evaluates opportunities for improving a result set, such as by increasing or decreasing a value of a qualitative aspect of the result set. Accordingly, via a preview feature of application 312 or another application, component 314 makes one or more suggestions for using additional or different cubes in combination with the cubes selected by component 310, so that one or more qualitative aspects of the result set can be improved. Component 314 performs qualitative improvement-based pricing computation for the combination of cubes, including these additional or different cubes, as described elsewhere in this disclosure.

Component 316 performs the billing for the data cubes used in executing the query. For example, component 316 bills the user, debits the user's account, credits the accounts associated with the sellers of the used data cubes, or a combination thereof.

With reference to FIG. 4, this figure depicts an example set of sellers' features on an example user interface in accordance with an illustrative embodiment. Interface 400 is presented during the functions of component 304, 306, or both, in FIG. 3. Interface 400, its layout, contents, or types of controls depicted in FIG. 4 are only examples for describing certain features of an embodiment, and are not intended to be limiting on the illustrative embodiments. Other similar features, additional features, or different features will be conceivable from this disclosure and the same are contemplated within the scope of the illustrative embodiments.

In the example depiction, interface 400 provides controls 402 to allow a seller to describe the data cube. For example, using controls 402, a seller specifies whether the cube includes data older than a certain time, data newer than a certain time, data cached from the cube, or a combination thereof. Using controls 402 or additional or different controls (not shown), the seller can also indicate whether the pricing applies to old records in the cube, new records in the cube, cached records of the cube, or a combination thereof.

Control 404 allows the seller to provide information about the source of the data in the data cube. Often, a decision whether to use a certain cube in a query depends, at least in part, on the provenance of the source. As an example, using control 404 or additional or different controls (not shown), the seller can provide the provenance information about the data source.

Using controls 406, the seller can specify whether the seller will allow only parts of the data cube to be selected for participation in a query. Controls 406 further allow the seller to specify the smallest portion of the data cube that can be sold, leased, traded, or otherwise used with payment in a query. For example, if the cube comprises ten columns, the seller can specify that the smallest portion tradable from the cube is a row or more of all columns, some rows of some columns, or an individual cell.

Controls 408 allow the seller to define one or more pricing rules for the data cube. The seller can define a partial-cube pricing model of any type and with any level of detail with the help of depicted controls and other controls. Any number or type of other controls (not shown for simplifying the figure), can be configured in interface 400 to allow the seller to define selection, participation, and pricing for several portions of the data cube at any level of granularity.

The seller can also choose to allow or disallow result-improvement-based pricing adjustment as described elsewhere in the disclosure. For example, and without implying any limitations thereto, control 408A allows a seller to specify pricing adjustments in proportion to the improvement the cube or a portion thereof contributes to the result set. For example, if the confidence rating of the result set changes from sixty percent to seventy five percent—an improvement of twenty five percent—control 408A would allow an embodiment to increase the price of the cube by twenty five percent or multiples or fractions thereof. As another example, if the average age of the result set changes from one year old to three months old—an improvement of seventy five percent—control 408A would allow an embodiment to increase the price of the cube by seventy five percent or multiples or fractions thereof. As another example, if the number of records in the result set changes from five hundred to fifty—an improvement of ninety percent—control 408A would allow an embodiment to increase the price of the cube by ninety percent or multiples or fractions thereof. From this disclosure, those of ordinary skill in the art will be able to conceive many other ways of improvement-proportional pricing adjustments, even methods involving indirect or nonlinear proportionality, and the same are contemplated within the scope of the illustrative embodiments.

As another example, and without implying any limitations thereto, control 408B allows a seller to specify pricing adjustments in steps depending on a degree of improvement the cube or a portion thereof contributes to the result set. For example, assume that in one example embodiment, example pricing adjustment allows an increase/decrease of price by one dollar for each step of five percent increase/decrease in the confidence rating, not to exceed a total price adjustment of three dollars. If the cube causes the confidence rating of the result set to change from sixty percent to ninety five percent, control 408B would allow an embodiment to increase the price of the cube by three dollars for the six step increase in the confidence rating.

For example, assume that in another example embodiment, example pricing adjustment allows an increase/decrease of price by one dollar for each step of fifty records change in the size of the result set, without a limit on the total price adjustment. If the cube causes the size of the result set to change from five hundred records to one hundred records, control 408B would allow an embodiment to increase (or decrease) the price of the cube by eight dollars for the eight step change in the size of the result set. If the reduction in size is desirable according to the call of the query, the price of the cube increases, if the reduction in size is not desirable according to the call of the query, the cube may be eliminated from the set of cubes, or the price of the cube may be decreased (such as when using the cube is desirable for some other reason.)

Note that the pricing models depicted in FIG. 4 are only examples to describe a concept. These example pricing models are not intended to be limiting on the illustrative embodiments. From this disclosure, those of ordinary skill in the art will be able to conceive many other ways of result-improvement-based pricing adjustments, even methods involving these and other qualitative aspects as well as interpretations thereof, and the same are contemplated within the scope of the illustrative embodiments.

Controls 410 allow the seller to select the types of trades in which the data cube can participate. For example, some cubes may only be bought, while others may be leased, rented, borrowed, bartered, or otherwise traded for a payment in any suitable manner.

The seller can also specify limits on the pricing of the data cube. For example, controls 412 allow the seller to specify an absolute pricing upper limit for the entire cube, different pricing limits for different trading options, different portions, different types of participation in queries, or a combination of these and several other conditions.

As described elsewhere, an embodiment allows a user to preview the potential benefits from using a particular cube before committing to buy or trade for the cube. Control 414 allows a seller to specify whether the cube or a portion thereof can be previewed without purchasing.

Additional controls (not shown) can implement additional or different features 416 in interface 400. For example, additional controls can restrict particular usage of the cube, such as in the example described earlier about individually identifiable information in healthcare data. Many variations of these features, additional details in the depicted example features, additional features, and different features for a similar purpose of offering a seller control over the pricing and usage of their data cubes will be apparent from this disclosure. The same are contemplated within the scope of the illustrative embodiments.

With reference to FIG. 5, this figure depicts an example set of users' features on an example user interface in accordance with an illustrative embodiment. Interface 500 is presented during the functions of component 310 in FIG. 3. Interface 500, its layout, contents, or types of controls depicted in FIG. 5 are only examples for describing certain features of an embodiment, and are not intended to be limiting on the illustrative embodiments. Other similar features, additional features, or different features will be conceivable from this disclosure and the same are contemplated within the scope of the illustrative embodiments.

In the example depiction, interface 500 provides control 502 to allow a user to specify or modify a query. For example, using control 502, a user directly or indirectly specifies a query, a pseudo query, or a cube-consuming application, in a manner sufficient to identify one or more data cubes that can participate to generate a desired result set.

Control 504 allows the user to indicate whether the user wants the application, such as application 302 in FIG. 3, to automatically identify the cubes to use. For example, in some cases, the user may desire to select the cubes from the data store, whereas in other cases the user may desire to leave the selection to the application according to a user profile or user-specified criteria. As an example, using control 504 or additional or different controls (not shown), the user can specify one or more conditions under which the application should automatically select the data cubes to address the query.

Using control 506, the user can specify pricing threshold as one criterion to selecting the data cubes against which the application executes the query. For example, the user may expressly specify, or an account balance may implicitly limit, a total amount that the cost of using the data cubes cannot exceed.

Control 508 allows the user to indicate one or more qualitative aspects and their values or value-ranges desired in the result set. For example, control 508A allows the user to set a desired level of confidence of the result set. When evaluating additional or different data cubes that may improve the result set as described elsewhere in this disclosure, the application uses a value or value-range specified in control 508A to determine the suitability of the cube being evaluated.

As another example, control 508B allows the user to set a desired size of the result set, and control 508C allows the user to set a desired age of the result set.

Similarly, control 508D allows the user to set a desired relevance level of the records in the result set. For example, the example qualitative aspect of relevance indicates the relevance of a record to an objective of the query or another specified objective, using a scale of relevance.

Control 508E similarly allows the user to set a value or value-range of any number or types of other qualitative aspects of the result set. When evaluating an additional or different data cube that may improve the result set as described elsewhere in this disclosure, the application uses a value or value-range specified in controls 508A, 508B, 508C, 508D, 508E, or a combination thereof, to determine the suitability of the cube for use with the query.

Using control 510, the user can authorize the application to automatically add data cubes to reach the target improvement in one or more qualitative aspects of the result set as specified in controls 508 and 508A-E. For example, in one embodiment, control 510 allows the application to change the pricing threshold of control 506, until one or more of the specified qualitative aspects reach the desired values or value-ranges according to controls 508A-E.

Control 512 allows the user to specify whether the user wishes to preview alternative combinations of data cubes with their corresponding qualitative improvements and pricing before making a decision on which combination of data cubes to buy, rent, or otherwise pay for. Control 514 allows the user to specify whether the application can consider useful but disqualified cubes in constructing the alternative combinations.

Additional controls (not shown) can implement additional or different features 516 in interface 500. For example, additional controls can restrict the selection of data cubes to cubes from certain sources, such as sources of certain provenance. Many variations of the depicted example features, additional details in the depicted example features, additional features, and different features for a similar purpose of offering a user control over the usage of data cubes and price the user pays for such usage will be apparent from this disclosure. The same are contemplated within the scope of the illustrative embodiments.

None of the features described in FIGS. 4 and 5 are necessary for the operation an embodiment. For example, an embodiment can use defined values from profiles, default values in an environment, machine learning based learned preferences, and other ways for configuring similar features, and the same are contemplated within the scope of the illustrative embodiments.

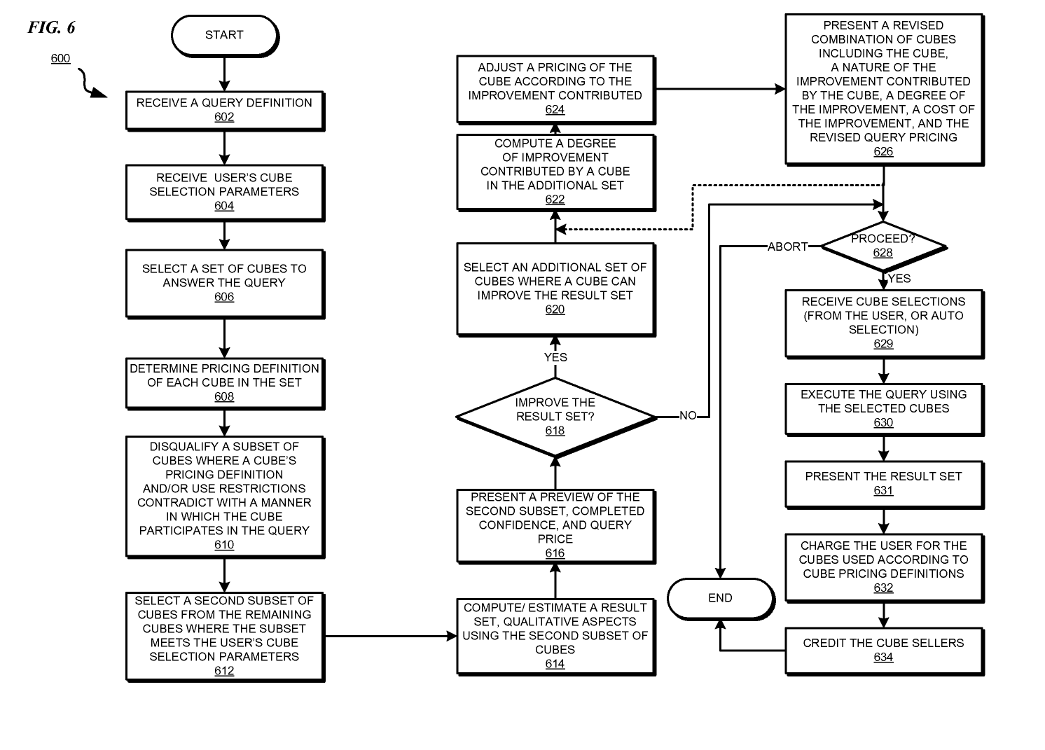

With reference to FIG. 6, this figure depicts a flowchart of an example process for pricing data according to qualitative improvement in a query result set in accordance with an illustrative embodiment. Process 600 can be implemented in application 302 in FIG. 3.

The application receives a query definition (block 602). The application receives a set of parameters defined by the user to guide the selection of the data cubes to answer the query (block 604).

The application selects a set of data cubes according to the user's cube selection parameters of block 604 to answer the query (block 606). The application determines one or more pricing definitions applicable to each data cube in the identified set of cubes (block 608).

The application forms a subset of disqualified cubes (block 610). The application adds a cube to the subset of disqualified cubes when a cube's pricing definition, use restrictions, or both, contradict with a manner in which the cube is expected to participate in the query.

After removing the subset of disqualified cubes, the application selects a second subset of cubes from the remaining cubes in the set of cubes (block 612). The combination of cubes in the second subset meets the user's cube selection parameters received in block 604.

The application computes or estimates an expected result set and the corresponding qualitative aspects when the cubes in the second subset are used (block 614). A query price, to wit, the price for using the selected cubes to answer the query, e.g., the second subset of cubes in this case, is also computed in block 614. The application presents a preview of the second subset, the computed or evaluated result set, the corresponding qualitative aspects of the result set, and the price of executing the query using the second subset of cubes to the user (block 616). Note that the pricing of the data cubes in the second subset is also adjustable based on the qualitative contributions of those data cubes to the result set.

The application determines whether the user has accepted the second subset, or whether the user wishes to improve the result set (block 618). If the user accepts the second subset, (“No” path of block 618), the application proceeds to block 628. If improvement is desired (“Yes” path of block 618), the application selects an additional set of cubes where the cubes in the additional set can improve a qualitative aspect of the result set of block 614 (block 620).

In one embodiment, the additional set of cubes is distinct from the set of cubes selected in block 606. In another embodiment, the additional set of cubes is a third subset from the set selected in block 606. The third subset can include a cube from the disqualified subset, a cube that is a member of the set but is not a member of either the disqualified subset or the second subset, or a combination thereof.

The application computes a degree of improvement contributed to the result set by a cube in the additional set (block 622). The application adjusts the pricing of the cube from the additional set according to qualitative improvement contributed to the result set by such cube (block 624).

The application revises the combination of cubes used in block 616. For example, the application revises the composition of the second subset by adding the cube from the additional set from block 622 to the second subset. The application presents as an improvement alternative, the revised second subset, one or more improved qualitative aspects of the result set, and a revised pricing for using the revised second subset for the query (block 626). Note that the result set may also be revised due to the participation of the cube from the additional set. The application returns to block 622 and repeats block 622, 624, and 626 for any number of different revised second subsets of the cubes as long as the different revised second subsets improve one or more qualitative aspects of the result set. In one embodiment, the application does not present an alternative as an improvement alternative if the improvement remains below a lower threshold of improvement in one or more qualitative aspects.

The application determines, such as from a user input, whether the user has decided to proceed with the cube purchase or abort the cube purchase (block 628). If the user has decided to abort the purchase (“Abort” path of block 628), the application ends process 600 thereafter without completing the purchase or trade of any data cube. If the user has decided to proceed (“Yes” path of block 628), the application receives a selection of cubes (block 629). The selection corresponds to either the cubes in the second subset of block 616, or the cubes in one of the improvement alternatives presented in block 626. In one embodiment, the application receives the selection from the user. In another embodiment, the application automatically makes the selection according to a user-specified criterion. In one embodiment, the application allows the user to modify an automatic selection.

The application executes the query using the selected cubes (block 630). In one embodiment, if the application has executed the query or a portion thereof for determining the result set in block 616 or block 626, the application omits executing the query or the portion thereof in block 630 and simply reuses the result set obtained during the execution at block 616 or block 626.

The application charges the user for the used cubes according to the cube pricing definitions of those cubes (block 632). The application credits the sellers of the used cubes according to the usage (block 634). The application ends process 600 thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for pricing data according to qualitative improvement in a query result set.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable storage medium. A computer readable storage device may be, for example, but not limited to, an electronic, magnetic, optical, electromagnetic, or semiconductor system, apparatus, or device, or any suitable combination of the foregoing. More specific examples (a non-exhaustive list) of the computer readable storage device would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can store a program for use by or in connection with an instruction execution system, apparatus, or device. The term “computer readable storage device,” or variations thereof, does not encompass a signal propagation media such as a copper cable, optical fiber or wireless transmission media.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for pricing data according to a qualitative improvement of a result from using the data, the method comprising:
identifying, a set of data cubes according to a set of cube selection parameters, wherein a data cube in the set of data cubes comprises a quantum of data configured for trading in exchange for a payment, the set of data cubes being usable for answering a query;
selecting a first subset of qualified data cubes from the set of data cubes, wherein a first subset of needed data cubes from the first subset of data cubes is usable to execute the query and form an unimproved result set for a first price, the unimproved result set achieving a first value of a qualitative aspect;
selecting a second subset of participating data cubes from the first subset of qualified data cubes;
computing, using a processor and a memory, a second value of the qualitative aspect of a result set of the query, wherein at least a portion of the second value of the qualitative aspect is contributed by a participating data cube from the second subset, the portion forming a degree of qualitative contribution of the participating data cube, wherein the second value of the qualitative aspect of the result set exceeds the first value of the qualitative aspect of the unimproved result set;
adjusting a price of the participating data cube according to the degree of qualitative contribution of the participating data cube, forming an improvement-based adjusted price;
computing a total price of using the second subset of participating data cubes for the query, the computing including the improvement-based adjusted price; and
comparatively presenting the second subset of participating data cubes, the result set, the second value of the qualitative aspect, and the total price of using the second subset of participating data cubes for the query, in comparison with the first price and the first value of the qualitative aspect.

2. The method of claim 1, wherein the presenting further includes the degree of qualitative contribution of the participating data cube.

3. The method of claim 1, wherein the qualitative aspect is indicative of a confidence level of the result set, and wherein the confidence level has a corresponding value-range, wherein the second value of the qualitative aspect being within the value-range is indicative of an acceptable quality of the result set.

4. The method of claim 1, wherein the qualitative aspect is indicative of an average age of records in the result set, and wherein the average age has a corresponding value-range, wherein the second value of the qualitative aspect being within the value-range is indicative of an acceptable quality of the result set.

5. The method of claim 1, wherein the qualitative aspect is indicative of a numerosity of records in the result set, and wherein the numerosity has a corresponding value threshold, wherein the second value of the qualitative aspect being above the value threshold is indicative of an acceptable quality of the result set.

6. The method of claim 1, wherein the qualitative aspect is indicative of a numerosity of records in the result set, and wherein the numerosity has a corresponding value threshold, wherein the second value of the qualitative aspect being below the value threshold is indicative of an acceptable quality of the result set.

7. The method of claim 1, further comprising:
disqualifying a subset of data cubes from the set of data cubes, forming a subset of disqualified data cubes, non-disqualified data cubes in the set forming the subset of qualified data cubes, wherein a pricing definition associated with a disqualified data cube in the subset of disqualified data cubes prevents the disqualified data cube from participating in the query.

8. The method of claim 1, further comprising:
selecting an additional set of alternative data cubes, wherein the additional set of alternative data cubes is distinct from the second subset of participating data cubes;
computing, corresponding to a revised result set, a revised value of the qualitative aspect, wherein at least a second portion of the revised value of the qualitative aspect is contributed by an alternative data cube from the additional set of alternative data cubes, the second portion forming a degree of qualitative contribution of the alternative data cube;
adjusting a price of the alternative data cube according to the degree of the qualitative contribution of the alternative data cube to the revised result set, forming an improvement-based adjusted price of the alternative data cube;
computing, using the improvement-based adjusted price of the alternative data cube, a revised total price of the query to generate the revised result set; and
presenting an alternative selection of data cubes for answering the query, the alternative selection including the alternative data cube, further presenting the revised result set, the revised value of the qualitative aspect, and the revised total price.

9. The method of claim 8, wherein the additional set of alternative data cubes is a third subset from the set of data cubes.

10. The method of claim 8, wherein the presenting the alternative selection allows evaluating, prior to paying for the alternative data cube, the degree of qualitative contribution of the alternative data cube.

11. The method of claim 1, wherein the method is embodied in a computer program product comprising one or more computer-readable tangible storage devices and computer-readable program instructions which are stored on the one or more storage devices—and executed by one or more processors.

12. The method of claim 1, wherein the method is embodied in a computer system comprising one or more processors, one or more computer-readable memories, one or more computer-readable tangible storage devices and program instructions which are stored on the one or more storage devices for execution by the one or more processors via the one or more memories and executed by the one or more processors.

13. A computer program product for pricing data according to a qualitative improvement of a result from using the data, the computer program product comprising:
one or more computer-readable tangible storage devices;
program instructions, stored on at least one of the one or more storage devices, to identify a set of data cubes according to a set of cube selection parameters, wherein a data cube in the set of data cubes comprises a quantum of data configured for trading in exchange for a payment, the set of data cubes being usable for answering a query;
program instructions, stored on at least one of the one or more storage devices, to select a first subset of qualified data cubes from the set of data cubes, wherein a first subset of needed data cubes from the first subset of data cubes is usable to execute the query and form an unimproved result set for a first price, the unimproved result set achieving a first value of a qualitative aspect;
program instructions, stored on at least one of the one or more storage devices, to select a second subset of participating data cubes from the first subset of qualified data cubes;
program instructions, stored on at least one of the one or more storage devices, to compute a second value of the qualitative aspect of a result set of the query, wherein at least a portion of the second value of the qualitative aspect is contributed by a participating data cube from the second subset, the portion forming a degree of qualitative contribution of the participating data cube, wherein the second value of the qualitative aspect of the result set exceeds the first value of the qualitative aspect of the unimproved result set;
program instructions, stored on at least one of the one or more storage devices, to adjust a price of the participating data cube according to the degree of qualitative contribution of the participating data cube, forming an improvement-based adjusted price;
program instructions, stored on at least one of the one or more storage devices, to compute a total price of using the second subset of participating data cubes for the query, the computing including the improvement-based adjusted price; and
program instructions, stored on at least one of the one or more storage devices, to comparatively present the second subset of participating data cubes, the result set, the second value of the qualitative aspect, and the total price of using the second subset of participating data cubes for the query, in comparison with the first price and the first value of the qualitative aspect.

14. The computer program product of claim 13, wherein the program instructions to present further includes the degree of qualitative contribution of the participating data cube.

15. The computer program product of claim 13, wherein the qualitative aspect is indicative of a confidence level of the result set, and wherein the confidence level has a corresponding value-range, wherein the second value of the qualitative aspect being within the value-range is indicative of an acceptable quality of the result set.

16. The computer program product of claim 13, wherein the qualitative aspect is indicative of an average age of records in the result set, and wherein the average age has a corresponding value-range, wherein the second value of the qualitative aspect being within the value-range is indicative of an acceptable quality of the result set.

17. The computer program product of claim 13, wherein the qualitative aspect is indicative of a numerosity of records in the result set, and wherein the numerosity has a corresponding value threshold, wherein the second value of the qualitative aspect being above the value threshold is indicative of an acceptable quality of the result set.

18. The computer program product of claim 13, wherein the qualitative aspect is indicative of a numerosity of records in the result set, and wherein the numerosity has a corresponding value threshold, wherein the second value of the qualitative aspect being below the value threshold is indicative of an acceptable quality of the result set.

19. The computer program product of claim 13, further comprising:
program instructions, stored on at least one of the one or more storage devices, to disqualify a subset of data cubes from the set of data cubes, forming a subset of disqualified data cubes, non-disqualified data cubes in the set forming the subset of qualified data cubes, wherein a pricing definition associated with a disqualified data cube in the subset of disqualified data cubes prevents the disqualified data cube from participating in the query.

20. A computer system for pricing data according to a qualitative improvement of a result from using the data, the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to identify a set of data cubes according to a set of cube selection parameters, wherein a data cube in the set of data cubes comprises a quantum of data configured for trading in exchange for a payment, the set of data cubes being usable for answering a query;
program instructions, stored on at least one of the one or more storage devices for execution by at least one of the one or more processors via at least one of the one or more memories, to select a first subset of qualified data cubes from the set of data cubes, wherein a first subset of needed data cubes from the first subset of data cubes is usable to execute the query and form an unimproved result set for a first price, the unimproved result set achieving a first value of a qualitative aspect;
program instructions, stored on at least one of the one or more storage devices for execution by at least one of the one or more processors via at least one of the one or more memories, to select a second subset of participating data cubes from the first subset of qualified data cubes;
program instructions, stored on at least one of the one or more storage devices for execution by at least one of the one or more processors via at least one of the one or more memories, to compute a second value of the qualitative aspect of a result set of the query, wherein at least a portion of the second value of the qualitative aspect is contributed by a participating data cube from the second subset, the portion forming a degree of qualitative contribution of the participating data cube, wherein the second value of the qualitative aspect of the result set exceeds the first value of the qualitative aspect of the unimproved result set;
program instructions, stored on at least one of the one or more storage devices for execution by at least one of the one or more processors via at least one of the one or more memories, to adjust a price of the participating data cube according to the degree of qualitative contribution of the participating data cube, forming an improvement-based adjusted price;
program instructions, stored on at least one of the one or more storage devices for execution by at least one of the one or more processors via at least one of the one or more memories, to compute a total price of using the second subset of participating data cubes for the query, the computing including the improvement-based adjusted price; and
program instructions, stored on at least one of the one or more storage devices for execution by at least one of the one or more processors via at least one of the one or more memories, to comparatively present the second subset of participating data cubes, the result set, the value of the qualitative aspect, and the total price of using the second subset of participating data cubes for the query, in comparison with the first price and the first value of the qualitative aspect.
